(19) United States
(12) Patent Application Publication
(10) Pub. No.: US 2006/0084708 A1
(43) Pub. Date: Apr. 20, 2006

(54) Rigid foams with good insulation properties and a process for the production of such foams

(75) Inventors: Steven L. Schilling, Pittsburgh, PA (US); Kevin J. Elsken, Uppper Saint Clair, PA (US); Edward E. Ball, Weirton, WV (US)

Correspondence Address: BAYER MATERIAL SCIENCE LLC, 100 BAYER ROAD, PITTSBURGH, PA, 15205, US

(73) Assignee: Bayer MaterialScience LLC

(21) Appl. No.: 10/965,349

(22) Filed: Oct. 14, 2004

(51) Int. Cl. C08J 9/00

(52) U.S. Cl. 521/128; 521/129; 521/170; 521/172; 521/176

(57) ABSTRACT

Rigid foams having good insulation properties are made by reacting a polyisocyanate with an isocyanate-reactive material in the presence of a blowing agent composed of greater than about 0.5% by weight (based on total weight of foam forming materials) of water and less than about 12% by weight (based on total weight of foam forming materials) of HFC-245fa.

### BACKGROUND OF THE INVENTION

The present invention relates to a process for producing rigid foams, particularly, polyurethane/polyurea foams, with good insulation characteristics (as measured by k-factor) which may be produced more economically using 1,1,1,3,3-penta-fluoropropane and to the foams produced by this process.

Rigid polyurethane foams and processes for their production are known. Such foams are typically produced by reacting an isocyanate with an isocyanate-reactive compound such as a polyol in the presence of a blowing agent.

Among the blowing agents considered to be alternatives to the chlorofluorocarbons (CFCs) and the hydrogen-containing chlorofluorocarbons (HCFCs) which have been or are in the process of being phased out, are the hydrogen containing fluorocarbons referred to as “HFCs”. 1,1,1,3,3-penta-fluoropropane (HFC-245fa) and 1,1,1,2-tetrafluoroethane (HFC-134a) are considered to be the most likely HFC replacements for the commonly used 1,1-dichloro-1-fluoroethane (HCFC-141b) which is being phased out.

However, each of these HFC blowing agents has its disadvantages. HFC-245fa produces foams with good k-factors and is easy to handle but it is expensive and its high molecular weight makes it necessary to use it in larger quantities than other blowing agents. HFC-134a is less expensive than HFC-245fa and has a lower molecular weight than HFC-245fa. Consequently, HFC-134a can be used in smaller amounts than HFC-245fa. However, because of its low boiling point (−26° C.), HFC-134a is difficult to handle and higher water levels are often needed to obtain low foam densities. As a result of this higher water level and the higher thermal conductivity of HFC-134a, foams blown with HFC-134a have higher k-factors (i.e., less insulation value) than foams made with HFC-245fa.

One approach which has been taken to minimize the problems encountered with individual blowing agents is to use a combination of two or more blowing agents in which the relative amounts of the blowing agents are selected to achieve optimal foam properties. Such blowing agent mixtures are disclosed, for example, in U.S. Pat. Nos. 6,080,799 and 6,384,275.

The use of such mixtures, however, presents processing issues and requires additional plant equipment and space.

It would therefore be advantageous to develop an economical process for producing rigid polyurethane/urea foams having excellent thermal insulation properties using only one HFC blowing agent.

HFC-245fa is a known blowing agent. U.S. Pat. No. 5,883,142 discloses foams having k-factors of from 0.1447 to 0.1850 BTU in/hr.ft²° F. which were made with HFC-245fa in an amount of approximately 24.6% by weight, based on total weight of the isocyanate-reactive component. U.S. Pat. No. 6,086,788 discloses foams made with 23.3% by weight, based on total weight of isocyanate-reactive component, of HFC-245fa and 0.33% by weight of water, based on total weight of isocyanate-reactive component, produced foam having an initial k-factor of 0.150 BTU in/hr.ft²° F.

The k-factors of foams such those disclosed in U.S. Pat. Nos. 5,883,142 and 6,086,788 are not acceptable for most appliance insulation applications. Use of less HFC-245fa than the amounts disclosed in these patents would therefore be expected to produce foams with even less acceptable k-factors. Further, use of less HFC-245fa will adversely affect foam density. While water could be added to maintain the density of a foam produced with a lower amount of HFC-245fa, this leads to higher viscosity of the isocyanate reactive component, and the use of higher water levels leads to higher peak foam temperatures and a need to use a higher NCO/OH ratio. The use of large amounts of water will also result in a foam having higher urea and carbon dioxide contents which would also be expected to adversely affect at least some of the foam physical properties. The difficulties encountered with the use of more water and reduced levels of HFC-245fa are discussed in Doerge et al, “Appliance Foams with Reduced Levels of HFC-245fa”, Proceedings from the 2000 API Polyurethanes Conference, pages 445-452.

It would therefore be advantageous to develop a foam-forming system and process in which the optimum physical properties of the foam are obtained at the minimum cost without the need for significant change to the foam-forming production process.

### SUMMARY OF THE INVENTION

It is an object of the present invention to provide an economical process for the production of rigid polyurethane/polyurea foams blown with HFC-245fa having good insulation properties, as measured by k-factor.

It is also an object of the present invention to provide rigid polyurethane foams which are produced with HFC-245fa at reduced levels having insulation properties satisfying the requirements for use in appliances.

It is another object of the present invention to provide rigid polyurethane/urea foams having a thermal conductivity, as measured by k-factor, comparing favorably to that of rigid foams produced using the higher levels of HFC-245fa blowing agent commonly used in the appliance industry.

These and other objects which will be apparent to those skilled in the art are accomplished by reacting an organic isocyanate with an isocyanate-reactive compound in the presence of a blowing agent composition which includes greater than 0.5% by weight (based on total weight of foam forming materials) of water and less than 12% by weight (based on total weight of foam forming materials) of HFC-245fa.

### DETAILED DESCRIPTION OF THE PRESENT INVENTION

The present invention relates to a polyurethane/urea foam-forming reaction mixture which includes water and reduced levels of HFC-245fa, to a process for the production of rigid polyurethane foams in which a reduced amount of the blowing agent HFC-245fa is used and to rigid polyurethane foams having thermal conductivities as measured by k-factor comparable to those of foams produced using higher levels of HFC 245fa as the blowing agent. As used herein, “k-factor comparable to those of foams produced using higher levels of HFC-245fa” means a k-factor at 75° F. which is less than or equal to about 0.140 BTU in/hr.ft²° F., and preferably, less than or equal to 0.135 BTU in/hr.ft²° F.

The blowing agent composition of the present invention comprises greater than 0.5% by weight (based on total weight of foam forming materials), preferably from about 0.5 to 1.0% by weight, most preferably from about 0.5 to 0.9% by weight of water and less than 12% by weight, preferably from about 9.0 to 12.0% by weight, most preferably from about 9.5 to 11.5% by weight (based on the total weight of the foam forming material) of HFC-245fa.

1,1,1,3,3-pentafluoropropane (HFC-245fa) is known to those skilled in the art and is commercially available.

Rigid polyurethane/urea foams are prepared by reacting polyisocyanates with isocyanate-reactive compounds in accordance with methods known to those skilled in the art. Any of the known organic polyisocyanates may be used in the present invention. Suitable polyisocyanates include: aromatic, aliphatic and cycloaliphatic polyisocyanates and combinations thereof. Representative of these types are diisocyanates such as m- or p-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, isomers of hexahydrotoluene diisocyanate, naphthylene-1,5-diisocyanate, 1-methylphenyl-2,4-phenyl diisocyanate, diphenylmethane-4,4′-diisocyanate, diphenylmethane-2,4′-diisocyanate, 4,4′-biphenylene diisocyanate, 3,3′-methoxy-4,4′-biphenylene diisocyanate and 3,3′-dimethyldiphenylpropane-4,4′-diisocyanate; triisocyanates such as toluene-2,4,6-triisocyanate and polyisocyanates such as 4,4′-dimethyl-diphenylmethane-2,2′,5,5′-tetraisocyanate and the diverse polymethylene polyphenyl polyisocyanates.

A crude polyisocyanate may also be used in making polyurethanes, such as the crude toluene diisocyanate obtained by the phosgenation of a mixture of toluene diamines or the crude diphenylmethane diisocyanate obtained by the phosgenation of crude diphenylmethane diamine.

Especially preferred for making rigid polyurethanes are methylene-bridged polyphenyl polyisocyanates and prepolymers of methylene-bridged polyphenyl polyisocyanates, having an average functionality of from about 1.8 to about 3.5, preferably from about 2.0 to about 3.1, most preferably from about 2.5 to 3.0 isocyanate moieties per molecule and an NCO group content of from about 28 to about 34% by weight, preferably from about 28 to about 32% by weight. These isocyanates are preferred because of their ability to crosslink the polyurethane. The isocyanate index (ratio of equivalents of isocyanates to equivalents of active hydrogen-containing groups) is advantageously from about 0.9 to about 3.0, preferably from about 1.0 to about 2.0 and most preferably from about 1.0 to about 1.5.

Any of the known isocyanate reactive organic compounds may be used to produce foams in accordance with the present invention. Polyols or mixtures of polyols containing an average of at least two, preferably from about 3 to about 5, most preferably from about 3.5 to about 4.5 isocyanate-reactive hydrogen atoms and having a hydroxyl (OH) number of from about 200 to about 650 (preferably from about 350 to about 500) mg KOH/g are particularly preferred isocyanate-reactive compounds useful in the practice of the present invention. Polyols with suitable functionality and hydroxyl number may be prepared by reacting a suitable initiator containing active hydrogens with an alkylene oxide. Suitable initiators are those containing at least 2 active hydrogens or mixtures of initiators where the mole average of active hydrogens is at least 2, preferably from about 3 to about 8, and more preferably from about 4 to about 6. Active hydrogens are defined as those hydrogens which are observed in the well-known Zerewitinoff test. (See Kohler, Journal of the American Chemical Society, p.3181, Vol.49 1927). Representatives of such active hydrogen-containing groups include —OH, —COOH, —SH and —NHR groups where R is H or an alkyl group, or an aryl aromatic group and the like.

Examples of suitable aliphatic initiators include pentaerythritol, carbohydrate compounds such as lactose, α-methylglucoside, α-hydroxyethylglucoside, hexitol, heptitol, sorbitol, dextrose, mannitol, sucrose and the like, ethylene diamine and alkanol amines. Examples of suitable aromatic initiators containing at least four active hydrogens include aromatic amines such as isomers of toluene diamine, particularly ortho-toluene diamine, and methane diphenylamine, the reaction product of a phenol with formaldehyde, and the reaction product of a phenol with formaldehyde and a dialkanolamine such as those described in U.S. Pat. Nos. 3,297,597; 4,137,265 and 4,383,102. Other suitable initiators which may be used in combination with the initiators listed above include water, glycols such as propylene glycol, ethylene glycol, and diethylene glycol, glycerine, trimethylolpropane, hexane triol, aminoethyl piperazine and the like. Particularly preferred initiators for the preparation of the high functionality, high molecular weight polyols include sucrose, sorbitol, α-methylglucoside, toluene diamine, and ethylene diamine which may be employed separately or in combination with other initiators such as glycerine, glycols or water.

The polyols may be prepared by methods well known in the art such as those taught by Wurtz, The Encyclopaedia of Chemical Technology, Vol. 7, p. 257-266, Interscience Publishers Inc. (1951) and U.S. Pat. No. 1,922,459. For example, polyols can be prepared by reacting, in the presence of an oxyalkylation catalyst, an initiator with an alkylene oxide. A wide variety of oxyalkylation catalysts may be employed, if desired, to promote the reaction between the initiator and the alkylene oxide. Suitable catalysts include those described in U.S. Pat. Nos. 3,393,243 and 4,595,743. However, it is preferred to use as a catalyst a basic compound such as an alkali metal hydroxide, e.g., sodium or potassium hydroxide, or a tertiary amine such as trimethylamine. The reaction is usually carried out at a temperature of from about 60° C. to about 160° C., and is allowed to proceed using a ratio of alkylene oxide to initiator such that a polyol having a hydroxyl number ranging from about 200 to about 650, preferably about 300 to about 550, most preferably from about 350 to about 500 is obtained. The hydroxyl number range of from about 200 to about 650 corresponds to an equivalent weight range of from about 280 to about 86.

Polyols of a higher hydroxyl number than 650 may be used as optional ingredients in the process of the present invention. Aliphatic amine-based polyols having OH values greater than 650, preferably greater than 700 are particularly useful as optional ingredients.

The alkylene oxides which may be used in the preparation of the polyol include any epoxide or α,β-oxirane, and are unsubstituted or alternatively substituted with inert groups which do not chemically react under the conditions encountered during preparation of a polyol. Examples of suitable alkylene oxides include ethylene oxide, propylene oxide, 1,2- or 2,3-butylene oxide, the various isomers of hexane oxide, styrene oxide, epichlorohydrin, epoxychlorohexane, epoxychloropentane and the like. Most preferred, on the basis of performance, availability and cost are ethylene oxide, propylene oxide, butylene oxide and mixtures thereof, with ethylene oxide, propylene oxide, or mixtures thereof being most preferred. When polyols are prepared with combinations of alkylene oxides, the alkylene oxides may be reacted as a complete mixture providing a random distribution of oxyalkylene units within the alkylene oxide chain of the polyol or alternatively they may be reacted in a step-wise manner so as to provide a block distribution within the oxyalkylene chain of the polyol.

The polyamines useful as polyol initiators in the practice of the present invention may be prepared by any of the known methods. For example, via the nitration of an aromatic hydrocarbon with nitric acid followed by reduction, as in the preparation of toluene diamine (TDA), or via the reaction of ammonia with epoxides to obtain alkanol amines, such as ethanol amine, or via the condensation reaction of aldehydes with aromatic amines such as aniline to produce methylene bridged polyphenylpolyamines (polymeric methylene dianiline, otherwise known as MDA).

Suitable optional polyols include polyether polyols, polyester polyols, polyhydroxy-terminated acetal resins, hydroxy-terminated amines and polyamines. Examples of these and other suitable materials are described more fully in U.S. Pat. No. 4,394,491. Most preferred for preparing rigid foams are those having from about 2 to about 6 active hydrogens and having a hydroxyl number from about 50 to about 800, preferably from about 100 to about 650, and more preferably from about 200 to about 550. Examples of such polyols include those commercially available under the product names Terate (available from Invista Corporation) and Multranol (available from Bayer MaterialScience).

Other components useful in producing the polyurethanes of the present invention include surfactants, catalysts, pigments, colorants, fillers, antioxidants, flame retardants, stabilizers, and the like.

When preparing polyisocyanate-based foams, it is generally advantageous to employ a minor amount of a surfactant to stabilize the foaming reaction mixture until it obtains rigidity. Such surfactants advantageously comprise a liquid or solid organosilicon compound. Other, less preferred surfactants include polyethylene glycol ethers of long chain alcohols, tertiary amine or alkanolamine salts of long chain alkyl acid sulfate esters, alkylsulfonic esters, and alkylarylsulfonic acids. Such surfactants are employed in amounts sufficient to stabilize the foaming reaction mixture against collapse and the formation of large, and uneven cells. Typically, about 0.2 to about 2.5 parts of the surfactant per 100 parts by weight of foam forming composition are sufficient for this purpose.

One or more catalysts are advantageously used to produce foams in accordance with the present invention. Any suitable urethane catalyst may be used including any of the known tertiary amine compounds or organometallic compounds. Examples of suitable tertiary amine catalysts include triethylenediamine, N-methylmorpholine, pentamethyl diethylenetriamine, dimethylcyclohexylamine, tetra-methylethylenediamine, 1-methyl-4-dimethyl-aminoethyl-piperazine, 3-methoxy-N-dimethyl-propylamine, N-ethylmorpholine, diethylethanol-amine, N-cocomorpholine, N,N-dimethyl-N′,N′-dimethylisopropyl-propylene diamine, N,N-diethyl-3-diethyl aminopropyl amine and dimethylbenzyl amine. Examples of suitable organometallic catalysts include organomercury, organolead, organoferric and organotin catalysts, with organotin catalysts being preferred. Suitable organotin catalysts include tin salts of carboxylic acids such as dibutyltin di-2-ethyl hexanoate and dibutyltin dilaurate. Metal salts such as stannous chloride can also function as catalysts for the urethane reaction. A catalyst for the trimerization of polyisocyanates, such as an alkali metal alkoxide or carboxylate, may also optionally be employed. Such catalysts are used in an amount which measurably increases the rate of reaction of the polyisocyanate. Typical amounts are about 0.01 to about 2 part of catalyst per 100 parts by weight of foam forming composition.

The components described may be employed to produce rigid polyurethane and polyurethane-modified isocyanurate foams. The rigid foams of the present invention may be made in a one-step process by reacting all of the ingredients together at once, or foams can be made by the so-called “quasi-prepolymer” method. In the one-shot process where foaming is carried out using machines, the active hydrogen containing compounds, catalyst, surfactants, blowing agents and optional additives may be introduced separately to the mixing head where they are combined with the polyisocyanate to give the polyurethane-forming mixture. The mixture may be poured or injected into a suitable container or molded as required. For use of machines with a limited number of component lines into the mixing head, a premix of all the components except the polyisocyanate can be advantageously employed. This simplifies the metering and mixing of the reacting components at the time the polyurethane-forming mixture is prepared.

Alternatively, the foams may be prepared by the so-called “quasi-prepolymer” method. In this method, a portion of the polyol component is reacted in the absence of catalyst with the polyisocyanate component in a proportion such that from about 10 percent to about 30 percent free isocyanate groups are present in the prepolymer. To prepare foam, the remaining portion of the polyol is added to the prepolymer and the components are allowed to react together in the presence of a catalyst and other appropriate additives such as the blowing agent, surfactant, etc. Other additives may be added to either the isocyanate prepolymer or remaining polyol or both prior to the mixing of the components to produce a rigid polyurethane foam.

The foams of the present invention are characterized by k-factors comparable to those of rigid polyurethane/urea foams produced using higher levels of HFC-245fa as the blowing agent. More specifically, foams produced in accordance with the presence generally have a k-factor at 75° F. of less than 0.140 BTU in/hr.ft²° F., preferably less than or equal to 0.135 BTU in/hr.ft²° F., most preferably, approximately 0.133 BTU in/hr.ft²° F. or less.

The polyurethane foams of this invention are useful in a wide range of applications. Accordingly, not only can rigid appliance foams be prepared but spray insulation, rigid insulating board stock, laminates and many other types of rigid foam can easily be prepared according to this invention.

The following Examples are given as being illustrative of the present invention. All parts and percentages given in these Examples are parts by weight and percentages by weight, unless otherwise indicated.

### EXAMPLES

The following materials were used in the Examples which follow:
POLYOL A: A sucrose/propylene glycol/water/ethylene oxide/propylene oxide adduct having a functionality of about 5.2 and an OH number of about 470 mg KOH/g
POLYOL B: An o-toluenediamine/ethylene oxide/propylene oxide adduct having a functionality of 4 and an OH number of about 390 mg KOH/g.
POLYOL C: Stepanpol PS-2502A, an aromatic polyester polyol having a functionality of 2 and an OH number of about 240 which is commercially available from Stepan Company.
SURFACTANT: A silicone surfactant which is commercially available from Air Products and Chemicals Inc. under the designation Dabco DC-5357.
CATALYST A: A tertiary amine catalyst which is commercially available from Rhein Chemie Corporation under the name Desmorapid PV.
CATALYST B: A strongly basic, amber-brown liquid having a characteristic amine odor which is commercially available from Air Products under the designation Polycat 41.
CATALYST C: A potassium octoate catalyst solution which is commercially available from Air Products and Chemicals, Inc. under the name Dabco K 5.
HFC-245fa: 1,1,1,3,3-pentafluoropropane.
ISO: A modified polymeric MDI having an NCO group content of approximately 30.5% which is commercially available from Bayer MaterialScience under the name Mondur 1515.

### Examples 1-8

POLYOL A, POLYOL B, POLYOL C, SURFACTANT, CATALYST A, CATALYST B, CATALYST C, water and HFC-245fa were combined in the amounts indicated in Table 1. This mixture was then combined with the amount of ISO indicated in Table 1 in the Hennecke MQ-12-2 mixhead of an HK 100 high-pressure foam machine. The foaming mixture was then injected into a 120 ° F. mold made of aluminum measuring 200×20×5 cm (approximately 79×8×2 inches) in which it was allowed to foam and set. The properties of the foam are reported in Table 1.

TABLE 1

| | Example | | | | | | | |
|---|---|---|---|---|---|---|---|---|
| Material | 1* | 2* | 3 | 4 | 5 | 6 | 7 | 8 |
| POLYOL A (pbw) | 6.88 | 7.06 | 7.00 | 6.94 | 6.79 | 7.00 | 6.82 | 11.62 |
| POLYOL B (pbw) | 18.91 | 19.42 | 19.26 | 19.09 | 18.66 | 19.25 | 18.75 | 13.07 |
| POLYOL C (pbw) | 8.60 | 8.83 | 8.75 | 8.68 | 8.48 | 8.75 | 8.53 | 4.36 |
| SURFACTANT (pbw) | 1.38 | 1.43 | 1.20 | 1.20 | 1.20 | 1.10 | 1.20 | 1.15 |
| CATALYST A (pbw) | 0.54 | 0.53 | 0.49 | 0.41 | 0.39 | 0.33 | 0.37 | 0.44 |
| CATALYST B (pbw) | 0.27 | 0.27 | 0.24 | 0.21 | 0.19 | — | 0.18 | — |
| CATALYST C (pbw) | — | — | — | — | — | 0.17 | — | 0.22 |
| WATER (pbw) | 0.33 | 0.45 | 0.54 | 0.67 | 0.75 | 0.67 | 0.78 | 1.15 |
| HFC-245fa (pbw) | 13.47 | 12.45 | 11.51 | 10.49 | 10.52 | 10.51 | 9.51 | 8.54 |
| TOTAL ISOCYANATE- | 50.38 | 50.45 | 49.00 | 47.69 | 46.97 | 47.78 | 46.15 | 40.55 |
| REACTIVE COMPONENT | | | | | | | | |
| ISO. (pbw) | 49.62 | 49.55 | 51.00 | 52.31 | 53.03 | 52.22 | 53.85 | 59.45 |
| Overall Foam Density, lbs/ft³ | 2.10 | 2.08 | 2.11 | 2.10 | 2.07 | 2.12 | 2.10 | 1.98 |
| k-Factor @ 75° F., BTU-in./hr.ft²° F. | 0.130 | 0.130 | 0.132 | 0.133 | 0.133 | 0.134 | 0.134 | 0.138 |
| Core Density Average, lbs/ft³ | 1.96 | 1.89 | 1.90 | 1.92 | 1.88 | 1.94 | 1.92 | 1.82 |

*Comparative Example

It is evident from the data presented in the Table, that the foams made with the blowing agent composition of the present invention had a k-factor comparable to that of the foam blown with higher levels of HFC 245fa and lower levels of water.. The unexpectedly good k-factor obtained for the foam produced in accordance with the present invention was achieved using a smaller amount of the expensive blowing agent HFC-245fa.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1. A process for the production of a rigid foam comprising reacting
a) an organic isocyanate
with
b) an isocyanate reactive compound
in the presence of
c) a blowing agent comprising
(1) greater than about 0.5% by weight, based on total weight of foam forming materials, of water and
(2) less than to about 12% by weight, based on total weight of foam forming materials, of HFC-245fa
to produce a rigid polyurethane/urea foam having a K-factor at 75° F. which is less than 0.140 BTU in/hr.ft²° F.

2. A process for the production of a rigid foam comprising reacting
a) an organic isocyanate
with
b) an isocyanate reactive compound
in the presence of
c) a blowing agent comprising
(1) from about 0.5 to about 1.0% by weight, based on total weight of foam forming materials, of water and
(2) from about 9 to about 12%. by weight, based on total weight of foam forming materials, of HFC-245fa
to produce a rigid polyurethane/urea foam having a K-factor at 75° F. which is less than or equal to about 0.135 BTU in/hr.ft²° F.

3. The process of claim 1 in which blowing agent c) comprises
(1) from 0.5 to 0.9% by weight, based on total weight of foam forming materials, of water and
(2) from 9.5 to 11.5% by weight, based on total weight of foam forming materials, of HFC-245fa.

4. The process of claim 1 in which the isocyanate a) is a polymethylene polyphenyl polyisocyanate or polymethylene polyphenyl polyisocyanate prepolymer.

5. The process of claim 1 in which the isocyanate reactive compound b) is a polyol or polyol mixture having a hydroxyl number of from about 200 to about 650 mg KOH/g.

6. A rigid polyurethane foam produced by the process of claim 1.

7. A rigid polyurethane foam produced by the process of claim 2.

8. A foam-forming reaction mixture comprising:
a) an organic isocyanate,
b) an isocyanate-reactive compound and
c) a blowing agent comprising
(1) greater than about 0.5% by weight, based on total weight of foam forming materials, of water and
(2) less than 12% by weight, based on total weight of foam forming materials, of HFC-245fa.

9. A foam-forming reaction mixture comprising:
a) an organic isocyanate,
b) an isocyanate-reactive compound and
c) a blowing agent comprising
(1) from about 0.5 to about 1.0% by weight, based on total weight of foam forming materials, of water and
(2) from about 9 to 12% by weight, based on total weight of foam forming materials, of HFC-245fa.
